(19) United States
(12) Patent Application Publication
(10) Pub. No.: US 2008/0269974 A1
(43) Pub. Date: Oct. 30, 2008

(54) Method for Controlling the Driving Dynamics of a Vehicle, Device for Implementing the Method and Use Thereof

(75) Inventors: Ralf Schwarz, Ingolstadt (DE); Thomas Raste, Oberursel (DE); Steffen Troster, Metzingen (DE); Matthias Muntu, Frankfurt/M (DE)

Correspondence Address: CONTINENTAL TEVES, INC., ONE CONTINENTAL DRIVE, AUBURN HILLLS, MI, 48326-1581, US

(73) Assignee: Continental Teves AG &Co. oHG, Frankfurt am Main (DE)

(21) Appl. No.: 10/592,304

(22) PCT Filed: Mar. 9, 2005
(86) PCT No.: PCT/EP2005/051058

§ 371 Date: Jul. 2, 2008

(30) Foreign Application Priority Data
Mar. 11, 2004 (DE) 10 2004 012 318.7
Aug. 24, 2004 (DE) 10 2004 040 876.9

(51) Int. Cl. B60G 21/055

(52) U.S. Cl. 701/29

(57) ABSTRACT

Disclosed is a method of controlling the driving dynamics of a vehicle, in which a nominal value (\dot{ψ}_{ref}) of a driving state variable that corresponds to a preset driver input is compared with a detected actual value (\dot{ψ}) of the driving state variable, and in which a rolling moment distribution is detected and modified. The method is implemented in such a manner that the driving performance of the vehicle is determined by comparing the nominal value (\dot{ψ}_{ref}) of the driving state variable with the actual value (\dot{ψ}) of the driving state variable. Also, depending on the determined driving performance, a new rolling moment distribution is determined which corresponds to a predefined driving performance and the new rolling moment distribution is adjusted.

### BACKGROUND OF THE INVENTION

The present invention relates to a method for controlling the driving dynamics of a vehicle, in which a nominal value of a driving state variable that corresponds to a preset driver input is compared with a detected actual value of the driving state variable, and in which a rolling moment distribution is detected and modified.

The invention further relates to a device for implementing the method, which device is well suited for controlling the driving dynamics of a vehicle and comprises a means for the rolling moment support at a front axle and a rear axle of the vehicle, and sensors for detecting at least one driving state variable.

The term ESP (Electronic Stability Program) refers to yaw torque control operations, which take influence on the driving performance of a vehicle by way of an automatic buildup of pressures in individual wheel brakes and by means of an intervention into the engine management of the driving engine. Control intervention is performed when the difference between a measured actual yaw rate and a nominal yaw rate calculated based on a preset driver input exceeds a certain threshold value. The value of this difference dictates the type and intensity of the intervention.

The brake interventions and the interventions into the driving track will, however, cause the vehicle to slow down and are perceived by the driver as impairing the driving dynamics. Hence, the control interventions are not suited to improve the driving behavior of a vehicle in terms of handling and are carried out exclusively in critical driving situations.

Safety, comfort, and handling of a vehicle are basically determined by a spring suspension system and a damping at the wheels as well as by two stabilizers, which interconnect the right and the left wheel at the front and rear axles.

Chassis systems with adjustable dampers are known in the art, which reduce the dynamic rolling and increase the agility due to hardening of the damper depending on the lateral acceleration or the steering angle. The semi-active skyhook system represents an improvement of the adjustable damping systems, and the damping forces therein are adjusted on each individual wheel in such a fashion that the body behaves as if it is attached to the sky by a hook.

The use of these systems is above all seen in reducing the rolling of the vehicle body and, thus, in gaining driving comfort in first line.

In addition to influencing the chassis by actuating adjustable dampers, there is the possibility of changing the hardness of the stabilizers at the front axle and at the rear axle.

The stabilizers are usually designed as crossly arranged torsion springs, which are twisted in the event of rolling motion of the vehicle body, i.e. a springy movement of the wheels of an axle in opposite direction. Thereby, they provide a restoring moment about the roll axis and stabilize the vehicle.

The term ‘Dynamic Drive Control’ (DDC) refers to a method developed by BMW AG, in which a roll stabilization is performed by a distribution of the stabilizing moments between front and rear axles depending on the driving state. To be able to variably distribute the stabilizing moments, the stabilizers are divided, and a hydraulically operated swivel motor is connected on either side to the stabilizer halves. Thus, hydraulic pressure is used to individually adjust an appropriate stabilizing force at each wheel.

To control the roll stabilization, the lateral acceleration of the vehicle is detected, and a rolling moment to be expected due to high lateral acceleration is adjusted by a suitable stabilizer actuation control.

The prior art methods and systems are based on improving the driving dynamics of a vehicle in safety-critical or comfort-impairing driving situations.

In addition to this, however, there is the desire of influencing the vehicle characteristics depending on the driving situation or in a durable way.

In view of the above, an object of the invention involves adapting the driving performance of a vehicle in any desired driving maneuvers to a desired performance.

### SUMMARY OF THE INVENTION

According to the invention, this object is achieved by a method of controlling the driving dynamics of a vehicle, in which a nominal value (\dot{ψ}_{ref}) of a driving state variable that corresponds to a preset driver input is compared with a detected actual value (\dot{ψ}) of the driving state variable, and in which a rolling moment distribution is detected and modified. In the method a driving performance of the vehicle is determined by way of comparing the nominal value (\dot{ψ}_{ref}) of the driving state variable with the actual value (\dot{ψ}) of the driving state variable; depending on the determined driving performance, a new rolling moment distribution is determined which corresponds to a predefined driving performance; and the new rolling moment distribution is adjusted.

Further, the object is achieved by a device for controlling the driving dynamics of a vehicle, which comprises means for the rolling moment support at the front and rear axles of the vehicle and sensors for sensing at least one driving state variable (\dot{ψ}) for the vehicle. The device includes a subtracter (210) for determining a difference between a value of the driving state variable (\dot{ψ}_{ref}) adjusted by a driver and the detected value of the driving state variable (\dot{ψ}); a controller (220) for determining a correcting variable (u) by way of the difference between the value (\dot{ψ}_{ref}) adjusted by the driver and the detected value of the driving state variable (\dot{ψ}); a unit (230) for calculating changes of a wheel load differences at the front axle (ΔΔF_{VA}) and the rear axle (ΔΔF_{HA}) from the correcting variable (u) and a detected rolling moment distribution (w) between front and rear axles; an adder (240) for adding the calculated changes of the wheel load differences at the front axle (ΔΔF_{VA}) and the rear axle (ΔΔF_{HA}) to instantaneous wheel loads at the front axle (Δ\tilde{F}_{VA}) and at the rear axle (Δ\tilde{F}_{HA}); and an interface for actuating the means for the rolling moment support depending on the sum (ΔF_{VA}, ΔF_{HA}) of the calculated changes of the wheel load differences (ΔΔF_{VA}, ΔΔF_{HA}) and the instantaneous wheel load differences (Δ\tilde{F}_{VA}, Δ\tilde{F}_{HA}).

It is arranged that a method of controlling the driving dynamics of a vehicle is performed, in which a nominal value of a driving state variable that corresponds to a preset driver input is compared with a detected actual value of the driving state variable, and in which a rolling moment distribution of the vehicle is detected and modified. The method at issue is characterized in that the comparison of the nominal value of the driving state variable with its actual value is used to determine a driving performance of the vehicle, that depending on the determined driving behavior, a new rolling moment distribution is established, which corresponds to a predefined driving performance, and that the detected rolling moment distribution is adjusted.

The method of the invention permits identifying a driving maneuver desired by the driver, such as a cornering maneuver, by way of the nominal value of the driving state variable as adjusted by the driver and to ascertain the reaction of the vehicle by way of the actual value of the driving state variable. The reaction of the vehicle is compared with the driver's request and adapted to the driver's request by adjusting a suitable rolling moment distribution.

The method of the invention differs in this respect from methods in which measured values of driving state variables are compared with critical values, and a control action is performed when the threshold values are exceeded.

The comparison of a preset driver input with the vehicle reaction is used to implement the method irrespective of threshold values indicative of a critical driving performance. This fact allows adapting the driving performance to a desired driving performance even in the uncritical range, whereby the agility of the vehicle and, in addition to safety, also the fun of driving is enhanced.

Controlling the driving dynamics in uncritical driving situations is furthermore rendered possible in that the invention arranges for a change of the rolling moment distribution to influence the driving performance that remains unnoticed by the driver, what is in contrast to a deceleration of the entire vehicle or individual wheels that is performed by an ESP system in critical driving situations. Instead, the driver perceives improved handling and enhanced agility of the vehicle.

The change of the rolling moment distribution provided according to the invention can be carried out by an intervention into adjustable dampers and/or into a stabilizer at the rear axle and/or at the front axle.

A preferred embodiment of the method therefore is characterized in that the rolling moment distribution determined depending on the driving performance is adjusted by actuation of at least one stabilizer at a front and/or rear axle of the vehicle.

In another favorable embodiment, the rolling moment distribution is adjusted by actuating at least one adjustable damper at a wheel.

The rolling moment support at the front and rear axles results from the wheel load differences at this axle, and the adjustment of a new rolling moment distribution causes a change in the wheel load differences at the front and rear axles. In order not to shift the wheel load differences at the axles actively in the direction of the right or the left wheel, preferably both dampers at an axle are actuated.

The invention enables taking influence on the horizontal dynamics by changing the vertical dynamics of the vehicle. The intervention into the rolling moment distribution can be performed dynamically, that means briefly during a driving maneuver. However, the rolling moment distribution can be adjusted statically as well.

The embodiment of the method, in which a dynamic change of the rolling moment distribution is provided, more particularly serves as an improvement of the driving performance during defined driving maneuvers.

In the embodiment in which the rolling moment distribution is statically changed, a desired driving performance can be durably impressed on the vehicle, which superposes the mechanically induced vehicle layout.

The method of the invention is especially suited to influence the self-steering behavior of the vehicle.

Therefore, in a preferred embodiment of the method of the invention, a new rolling moment distribution is adjusted, which corresponds to a predetermined self-steering behavior.

Hence, the invention allows correcting an oversteering or understeering driving performance and/or adjusting a slightly oversteering or understeering driving performance, if this is desired. In doing so, it makes use of the knowledge that splitting the rolling moment in favor of the front axle, i.e. a split-up where a higher rolling moment is supported at the front axle than at the rear axle, causes understeering of the vehicle, while a split-up in favor of the rear axle furthers oversteering of the vehicle.

These effects found on the distribution of the sum of side forces at the axles. A greater rolling moment support at one axle has a greater difference in wheel loads as a consequence, leading to a reduced sum of side forces. This necessitates a larger king pin inclination at this axle so that an oversteering or understeering driving performance is the result.

A displacement of the rolling moment support in the direction of the front or rear axles can be achieved by increasing the rigidity of the stabilizer at the rear or front axles. Likewise, the rolling moment support can thus be displaced in the direction of the front or rear axles because adjustable dampers at the front or rear axles are adjusted to be harder.

It is provided by the invention that the new rolling moment distribution, which corresponds to the desired self-steering behavior, is established depending on a self-steering behavior found in a comparison between a nominal value and an actual value of a driving state variable.

In a particularly favorable embodiment of the method, the driving performance is determined using a comparison between a nominal yaw rate and a detected actual yaw rate.

The nominal yaw rate is then determined in a vehicle model by way of a steering angle adjusted by the driver and a vehicle longitudinal speed. It corresponds to the yaw rate, which would result for the vehicle if it followed the preset driver input in an idealized or desired fashion.

In particular the self-steering behavior of the vehicle can be determined using the comparison between normal and actual yaw rates.

In a particularly advantageous embodiment of the method, a neutral, understeering, or oversteering driving performance is detected, if the amount of the nominal yaw rate is exactly as high as, higher, or smaller than the amount of the actual yaw rate.

It is, however, also feasible to determine the self-steering behavior e.g. by way of a comparison between the steering angle and the sideslip angle.

In a favorable embodiment of the method of the invention, the rolling moment distribution of the vehicle, upon detecting understeering of the vehicle, is adjusted in such a manner that the rolling moment support is shifted in the direction of the rear axle.

This is done by setting the stabilizer and/or the dampers at the rear axle to be harder, and due to the effect previously described leads to a driving performance that is changed in the direction of oversteering.

Accordingly, the rolling moment support is displaced in the direction of the front axle if oversteering of the vehicle is identified in a likewise favorable embodiment.

In the method of the invention, the nominal yaw rate and the actual yaw rate are favorably determined and compared within a control cycle. Due to the elasticity and inertia of the vehicle and single components of the chassis, the nominal yaw rate signal in the phase is far ahead of the signal of the actual yaw rate, which mirrors the reaction of the vehicle to a driver's action. Thus, there is sufficient time to perform an actuation of the stabilizer and/or dampers, even at a high dynamics of signals, so quickly that the vehicle reaction is influenced.

A special advantage of the method of the invention, thus, also involves that the vehicle reaction can be adapted in due time and effectively to a desired vehicle reaction.

Indeed, it has shown that good results can be achieved in many driving situations with the aid of the previously presented control strategy.

In a likewise favorable embodiment of the method of the invention, it is however possible to intervene into the driving performance of the vehicle at an earlier time still.

As this occurs, the gradients of vehicle state variables, hence, the time variations of the variables, are taken into account, which are usually also referred to as accelerations.

In a preferred embodiment, the vehicle performance is determined using a comparison between nominal yaw acceleration and actual yaw acceleration. The nominal yaw acceleration, in turn, is determined using the steering angle gradient adjusted by the driver and the vehicle longitudinal speed, or with the aid of a differentiator from two temporally adjacent values of the nominal yaw rate. The actual yaw acceleration is achieved from the change of the actual yaw rate.

Any possibly imminent oversteering or understeering can then be detected by a divergence of the gradients of nominal and actual yaw rate, that is nominal and actual yaw accelerations.

Any oversteering or understeering action to be expected is again avoided in this embodiment of the method because the rolling moment support is displaced in the direction of the front or rear axles.

Furthermore, it is especially favorable to integrate the method of the invention into a method for yaw torque control.

This could e.g. be achieved by interaction of the functions of a conventional ESP method with those of the method of the invention.

Therefore, it is provided in a favorable embodiment that in addition to the stabilizer and/or damper intervention, a brake and/or engine intervention is performed depending on a result of a comparison between the nominal and the actual yaw rate and/or between the nominal and the actual yaw acceleration. The brake intervention is favorably executed on at least one wheel then.

In addition, the interventions are conformed to each other in a favorable embodiment of the method.

It is this way possible to integrate the method of the invention into existing methods for driving dynamics control that found on brake and/or engine interventions, and in particular for yaw torque compensation. The corresponding sensor system for detecting driving state variables, which is e.g. provided in an ESP system, can also be utilized.

Thus, the method of the invention obviates the need for a brake intervention for driving dynamics control, e.g. due to changing the rolling moment distribution at an early point of time.

Besides, the stabilizer, damper, brake and engine interventions are performed in consideration of a critical value of the driving state variable in a favorable embodiment of the method.

The critical value of the driving state variable preferably represents a limit value for the driving state variable in consideration of the physical realization of driving states.

Thus, the control interventions according to the method of the invention should favorably be carried out in such a fashion that the actual value of the driving state variable will never exceed the critical value.

In addition, the invention provides a device for controlling the driving dynamics of a vehicle, which comprises means for the rolling moment support at the front and rear axles of the vehicle and sensors for sensing at least one driving state variable for the vehicle. The device is characterized in that it is equipped with a subtracter for determining a difference between a value of the driving state variable adjusted by a driver and the detected value of the driving state variable, a controller for determining a correcting variable by way of the value adjusted by the driver and the detected value of the driving state variable, a unit for calculating changes of a wheel load difference at the front and rear axles from the correcting variable and a detected rolling moment distribution between front and rear axles, an adder for adding the calculated changes of the wheel load differences to instantaneous wheel loads, and an interface for an actuation of the means for the rolling moment support depending on the sum of the calculated change of the wheel load differences and the instantaneous wheel loads.

This device is especially apt for implementing the method of the invention. It further includes the advantage of permitting an especially safe implementation of the method.

The unit for calculating the change in the wheel load difference completely determines the new rolling moment distribution in order to determine these changes compared to the detected rolling moment distribution. With respect to the safety of the device, it is however especially advantageous to further process only the changes of the detected rolling moment distribution so that the latter remains affected upon failure of the unit.

Thus, the design of the invention also allows in a favorable manner to make the device ‘fail-silent’. When malfunction is detected, the device can be disabled, and the rolling moment distribution can be adjusted or remains unchanged without the device having any effect on it.

In a preferred embodiment, the means for the rolling moment support is configured as stabilizers.

In a likewise preferred embodiment, the means for the rolling moment support are adjustable dampers.

Further, the device favorably comprises at least one sensor for sensing the yaw rate.

It is additionally very favorable that the controller is a PD controller, i.e. a proportional controller having a differential component. Apart from changing the control variable, the controller itself renders it possible to consider the rate of change. This way, the divergence of the gradients of the nominal variation of the driving state variable and those of the actual variation of the driving state variable can be identified and considered in the control.

In this arrangement, the P-component (proportional component) of the PD controller takes the yaw rate into consideration, while the D-component (differential component) considers the yaw acceleration in a preferred embodiment of the device.

It has been explained before that the method of the invention can be integrated into an ESP control in a favorable manner. Therefore, the device is likewise suitable, with special advantages, for use in a system for yaw torque compensation (ESP system).

Further favorable embodiments of the invention can be seen in the detailed explanation of the invention and by way of the accompanying drawings.

### BRIEF DESCRIPTION OF THE DRAWINGS

In the drawings:

FIG. 1 shows a time variation of a nominal and an actual yaw rate with a plotted gradient;

FIG. 2 is a view of the control strategy using the method of the invention with components of the device for implementing the method of the invention, and

FIG. 3 shows the time variation of the vehicle speed and the yaw rate in the case of a double change of lanes with and without damper support.

### DETAILED DESCRIPTION OF THE DRAWINGS

The invention provides a favorable yaw-rate-responsive and yaw-acceleration-responsive control of the rolling moment distribution of a vehicle. Said control is used especially for assisting the known electronic stability program (ESP) and can also be performed in particular in uncritical driving situations in order to improve the driving performance of the vehicle in any desired driving situations.

The method of the invention is based on influencing the horizontal dynamics of a vehicle by varying the characteristics of the vertical behavior. This occurs by a distribution of the rolling moment using adjustable stabilizers or adjustable dampers.

The stabilizer and/or damper actuation not only aims at a rolling compensation but serves to reduce and possibly prevent brake interventions of the ESP control above all in the handling range and in the stability limit of the vehicle.

In this arrangement, the stabilizer and/or damper actuation can be combined with the brake and engine intervention executed by ESP control in a favorable manner and leads to a safer and more comfortable driving performance.

A brake intervention by a conventional ESP control can be sensed by the driver as vehicle deceleration and, therefore, is performed only in a critical driving situation. A stabilizer or damper actuation remains unnoticed by the driver, if it is harmoniously tuned, and can be utilized also in the uncritical range to influence the driving performance and in particular the self-steering behavior of the vehicle.

Apart from a dynamic adjustment of the stabilizers and/or the dampers during a rolling movement of the vehicle, the method of the invention likewise permits statically adjusting the rolling moment distribution. Thus, the self-steering behavior can be durably influenced and adapted to a desired self-steering behavior.

In the following, above all one embodiment of the invention is described in which the self-steering behavior of a vehicle is determined by comparing a nominal yaw rate \dot{ψ}_{ref} with an actual yaw rate \dot{ψ}, and is changed with the aid of the method of the invention. In other embodiments, however, it is likewise possible to ascertain the self-steering behavior in a different manner. Thus, the driving performance can be evaluated using the lateral acceleration, for example.

The nominal yaw rate \dot{ψ}_{ref} is the yaw rate, which results for a vehicle reference model due to the steering behavior of the driver. A vehicle model is made the basis in this respect which founds on the stationary single-track model, in which the nominal yaw rate \dot{ψ}_{ref} is achieved by the relation

$${\dot{ψ}}_{ref} = δ \frac{v}{l + EG \cdot {v}^{2}}$$

from the steering angle δ at the wheel, the vehicle longitudinal speed v, the wheel base l, and the self-steering gradient EG of the vehicle.

The steering angle δ is usually detected by means of a steering wheel angle sensor. As there is a known and mostly fixed transmission ratio between the steering wheel angle and the steering angle δ at the wheel, the steering angle δ can be calculated from the steering wheel angle in a simple fashion.

The vehicle longitudinal speed v is typically derived from the wheel circumferential speed. The angular velocity of the wheel is sensed by means of a wheel speed sensor, and the wheel circumferential speed is calculated using the known radius of the wheels.

The self-steering gradient EG considers the self-steering behavior of the vehicle. According to the classical definition of the self-steering behavior, a vehicle acts in an oversteering, neutral, or understeering manner, if the self-steering gradient EG is inferior to zero, equal to zero, or exceeding zero.

In addition to the instantaneous values of the steering angle δ and the vehicle longitudinal speed v, which are used to determine the nominal yaw rate \dot{ψ}_{ref}, likewise the actual value \dot{ψ} of the yaw rate is measured by a yaw rate sensor.

The nominal yaw rate \dot{ψ}_{ref} indicates the value of the yaw rate, which would result for the vehicle if it followed the specifications of the driver in an idealized manner. It indicates thereby, which driving maneuver the driver intends to initiate.

In the phase the signal \dot{ψ}_{ref} lies far ahead of the actual yaw rate \dot{ψ} of the vehicle because the reaction of the vehicle shows a certain deceleration on account of the elasticity of vehicle elements and the inertia of the vehicle.

It can now be determined using the signal \dot{ψ}_{ref} to what extent the vehicle will be rolling in the time following. Initially, a high coefficient of friction μ of μ=1 is assumed in order to ensure a maximum safety reserve.

Due to the phase shift between the signal \dot{ψ}_{ref} and the trailing signal \dot{ψ}, there is enough time to initiate the stabilizer and/or damper actuation in due time in the presence of high signal dynamics, meaning an undoubted desired of the driver to change directions, before the vehicle starts to roll or changes its rolling behavior to a considerable degree.

As this occurs, the control strategy of the invention provides to initially take a decision based on the difference between the actual yaw rate \dot{ψ} detected during a control cycle and the determined nominal yaw rate \dot{ψ}_{ref}, as to whether the vehicle exhibits a neutral, an oversteering or understeering driving performance.

In this respect, the control cycle should roughly comprise the time span in which a measurable vehicle reaction to a driver's action is obtained, and it should be far shorter than the time span, in which the vehicle reacts completely to a driver's action in order that the final vehicle reaction can be influenced effectively.

The invention utilizes the known effect that a change of the rolling moment support on one axle results in a change of the wheel load difference and, hence, a change of the sum of side forces on this axle.

Thus, the driving performance of a vehicle can be varied by the variation of the available sum of side forces of front and rear axle.

If, for example, the stabilizer at the rear axle is adjusted to be harder and the one at the front axle to be softer, the wheel load difference during a rolling action at the rear axle will become greater than that at the front axle. By way of the degressive side force characteristic curve of the tires, this causes a reduction of the sum of side forces at the axle with the greater wheel load difference, meaning the rear axle in this case. The driving performance of the vehicle is thus changed towards a ‘more oversteering’ behavior.

Likewise the wheel load difference at the axles can be changed by adjustable dampers. A harder or softer adjustment of the dampers at an axle leads to a greater or smaller wheel load difference at this axle.

Using these observations, the method of the invention allows detecting and changing the driving performance in the following manner by way of a comparison of the signals \dot{ψ} and \dot{ψ}_{ref}:

If the amount of the nominal yaw rate \dot{ψ}_{ref} exceeds the amount of the actual yaw rate \dot{ψ}, hence, if |\dot{ψ}_{ref}|>|\dot{ψ}| applies, a tendency of the vehicle to understeer is detected. In dependence on the value of the difference |\dot{ψ}|−|\dot{ψ}_{ref}| and further parameters p, a new rolling moment distribution is then determined and adjusted, in which the rolling moment support is displaced in the direction of the rear axle. It is thereby achieved that the available sum of side forces is increased at the front axle and decreased at the rear axle. The result is that the yaw rate \dot{ψ} of the vehicle is increased and thereby approaches the preset driver input.

If the amount of the nominal yaw rate \dot{ψ}_{ref} is lower than the amount of the actual yaw rate \dot{ψ}, hence, if |\dot{ψ}_{ref}|<|\dot{ψ}| applies, a tendency of the vehicle to oversteer is detected. In dependence on the value of the difference |\dot{ψ}|−|\dot{ψ}_{ref}| and possibly further parameters p, a new rolling moment distribution is then determined and adjusted, in which the rolling moment support is displaced in the direction of the front axle. It is thereby achieved that the available sum of side forces is decreased at the front axle and increased at the rear axle. The result is that the yaw rate \dot{ψ} of the vehicle decreases and thereby approaches the preset driver input.

It has shown that this strategy allows obtaining good results in many driving situations. To be able to intervene into the driving performance of the vehicle still earlier, it is very favorable though to include an additional driving state variable into the control.

In one embodiment of the invention, therefore, the gradient of the actual yaw rate, i.e. an actual yaw acceleration, and the gradient of the nominal yaw rate, i.e. a nominal yaw acceleration, are determined as driving state variables which inform about how the vehicle will behave in the following time.

A comparison between the gradients renders it possible to determine oversteering or understeering that might be imminent. The comparison is performed similar to the comparison between the nominal yaw rate \dot{ψ}_{ref} and the actual yaw rate \dot{ψ}.

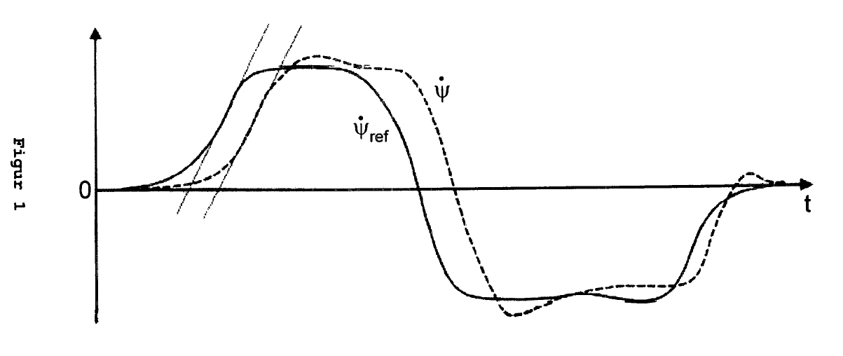

A time variation of the nominal yaw rate \dot{ψ}_{ref} and the actual yaw rate \dot{ψ} is illustrated in FIG. 1. Also, tangent lines are plotted at the curves, the upgrades of which correspond to the gradient of the quantities at the points of contact with the curves.

It can be recognized from the upgrades of the two curves that an oversteering or understeering behavior can be seen in the divergence of the gradients.

Thus, a new rolling moment distribution can thus be performed also depending on the difference d/dt(|\dot{ψ}_{ref}|−|\dot{ψ}|).

Thus, a stabilizer and/or damper actuation can be performed, which considers not only the deviation between nominal yaw rate \dot{ψ}_{ref} and actual yaw rate \dot{ψ} as a criterion for an intervention, but also the variation of the yaw rates itself.

It is especially favorable to determine the new rolling moment distribution both depending on the difference |\dot{ψ}_{ref}|−|\dot{ψ}| as well as depending on its time derivative d/dt(|\dot{ψ}_{ref}|−|\dot{ψ}|).

It is this way possible to actuate the stabilizers and dampers in a very safe, plausible, early and effective manner.

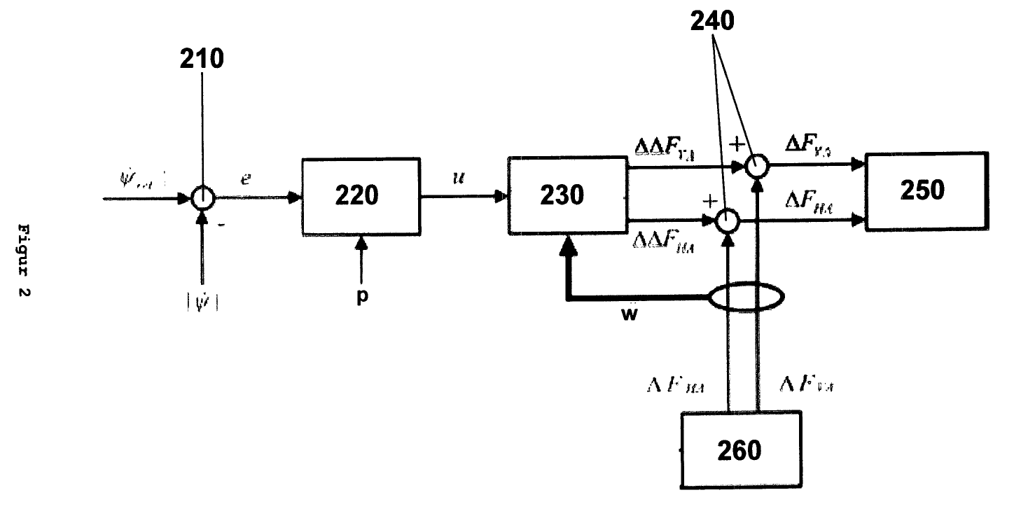

A realization of the control strategy presented hereinabove is illustrated in FIG. 2.

The signals of the amounts of the nominal yaw rate \dot{ψ}_{ref} and the actual yaw rate \dot{ψ} are sent to a subtracter 210, which outputs a difference between these two signals as controlled quantity ‘e’ serving as an input signal of a PD-controller 220.

In this proportional controller with a differential component, the correcting variable ‘u’ is not only influenced by a change of the controlled quantity ‘e’, but also by the latter's rate of change.

The P-component of the PD-controller 220 thus considers the difference |\dot{ψ}_{ref}|−|\dot{ψ}| and the D-component considers the differential quotient d/dt (\dot{ψ}_{ref}|−|\dot{ψ}|).

A demand for control is found out when the differences exceed a certain threshold value.

The PD-controller 220 calculates the correcting variable ‘u’ by way of the deviation between the actual yaw rate \dot{ψ} and the nominal yaw rate \dot{ψ}_{ref} and additionally in consideration of parameters ‘p’, which are adaptively adjusted to the desired vehicle performance and whose values are selected depending on the driving situation. Thus, the values of the parameters ‘p’ can e.g. be changed with the vehicle longitudinal speed ‘v’ and/or the yaw rate \dot{ψ}.

The driving characteristics of the vehicle can be changed by an adaptation of the parameters ‘p’. Thus, the latter parameterize the predetermined or desired driving performance.

When determining the correcting variable ‘u’, one parameter is likewise considered by a reference yaw rate, which indicates which yaw rate can be put into practice also physically in consideration of the installed self-steering behavior of the vehicle and the prevailing coefficient of friction of the roadway, without the vehicle losing its driving stability. The control is performed in such a way that the actual yaw rate \dot{ψ} does not exceed the value of the reference yaw rate.

The correcting variable ‘u’ calculated and output by the PD-controller 220 will now serve as an input variable for a unit 230 for calculating a new rolling moment distribution. The calculated changes of wheel load differences for the front axle (ΔΔF_{VA}) and the rear axle (ΔΔF_{HA}) from the correcting variable ‘u’ and the instantaneous rolling moment distribution (w) result from the instantaneous wheel loads at the front axle (Δ\tilde{F}_{VA}) and at the rear axle (Δ\tilde{F}_{HA}).

The instantaneous rolling moment distribution is calculated by the basic stabilizer control unit 260. As input variables, the basic stabilizer control unit 260 is e.g. furnished with the lateral acceleration of the vehicle and the vehicle speed v. A total rolling moment of the vehicle can be calculated with the aid of the lateral acceleration.

The counter rolling moment to be generated is calculated from the difference between the total rolling moment and the rolling moment of the springs depending on the roll angle of the vehicle and the lateral acceleration. This counter rolling moment is distributed differently onto the front and rear axles, dependent on the speed v, among others.

A rolling moment distribution is thereby achieved which can be converted into wheel load differences by way of the stabilizer geometry. Then, the unit 230 calculates from the difference between instantaneous wheel load distribution and the calculated new wheel load distribution changes of wheel load differences for the front axle (ΔΔF_{VA}) and the rear axle (ΔΔF_{HA}), which in turn are added by the adders 240 to the instantaneous wheel load differences at the front axle (Δ\tilde{F}_{VA}) and at the rear axle (Δ\tilde{F}_{VA}) in order to be able to transmit the new wheel load differences at the front axle (ΔF_{VA}) and at the rear axle (ΔF_{HA}) to the rolling stabilizer system 250.

The stabilizers are actuated by the rolling stabilizer system 250 using an interface.

The embodiment described hereinabove advantageously permits designing the device in a ‘fail-silent’ manner. In this embodiment, the system acts in a neutral way in the event of a detected error or malfunction. Thus, upon system malfunction, e.g. no change of wheel load differences (ΔΔF_{VA}, ΔΔF_{HA}) is submitted to the adder 240, whereby erroneous actuation of the stabilizers is prevented.

In a particularly preferred embodiment of the invention, the stabilizer and/or damper control is integrated into the usual ESP control, which adapts the actual performance of the vehicle to a nominal performance in critical driving situations by means of wheel-individual brake interventions.

ESP systems typically perform yaw rate control in critical driving situations and in particular prevent that the value of the yaw rate of the vehicle exceeds the values that can be physically realized.

The invention extends the adjustment possibilities of ESP control by an adaptation of the rolling moment distribution, which improves the driving performance both in critical driving situations and in the uncritical range. Thus, the invention represents a very favorable improvement of nowadays ESP systems.

The implementation of the stabilizer and/or damper actuation of the invention into an ESP system corresponds to an integrated approach. This approach founds on the fact that each one the individual systems of steering system, brake, chassis and driving track has a basic function. With respect to the horizontal dynamics, this basic function is limited to a mere control, such as a speed-responsive steering transmission or a brake force distribution to left-hand and right-hand wheel brakes responsive to lateral acceleration. The functions are in permanent exchange with the total horizontal dynamics controller in the ESP and report to it their instantaneous adjustment reserve and adjustment dynamics.

The central horizontal dynamics controller calculates in parallel from the preset driver input and the driving dynamics variables a desired vehicle performance and compares it with the actual vehicle performance currently determined by way of uniform sensor equipment. If the comparison requires a correction yaw torque, it will distribute said in knowledge of the driving state, the driver's request and the adjustment and dynamics reserves to the individual actuators.

The stabilizer or damper control of the invention fits into this concept in a very favorable manner.

In a favorable embodiment, the integration is further supported in that the stabilizer interface comprised in the device for implementing the method is designed according to a standard, which is used within the limits of the integrated approach. This allows interchanging rolling moments or a factor representative of the instantaneous rolling moment support with various systems. When this standard is preserved, it is also possible to integrate systems of different makers.

The adjustable dampers are also actuated using a standardized interface.

The method of the invention allows precluding the brake interventions of the ESP as regards the integration of different systems into an overall horizontal dynamics control system. As a result, the vehicle experiences less deceleration and driving it is more dynamical and harmonious.

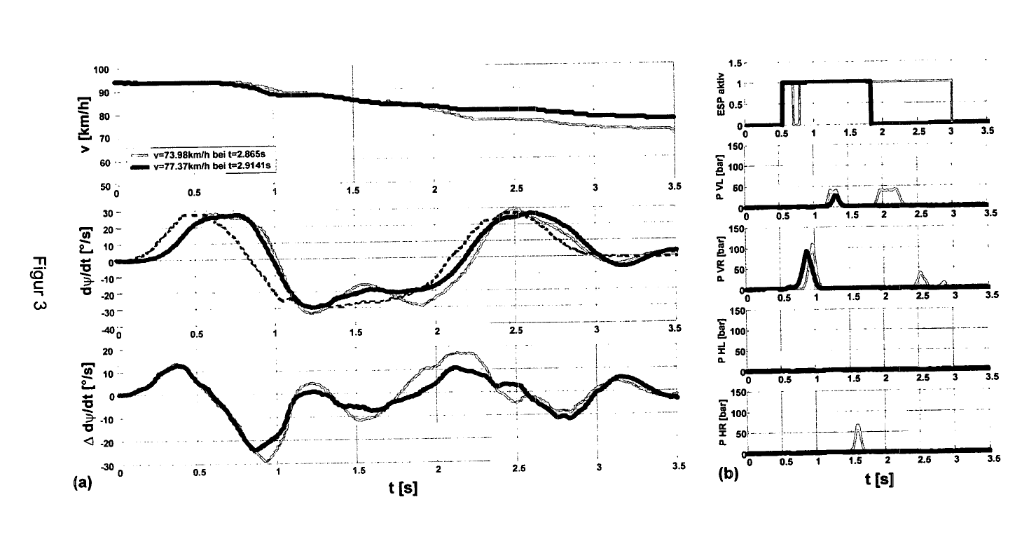

FIG. 3a shows the time variation of the speed v, the yaw rate \dot{ψ}, and the yaw rate errors Δ\dot{ψ} in the event of double lane change. The diagram shows the variation for a ride where the rolling moment support was performed by a skyhook control (dotted curve) and for a ride where the rolling moment support was performed by yaw rate control using an ESP system (curve with solid lines). The nominal yaw rate calculated by the ESP system is shown in a dotted line, and the yaw rate error Δ\dot{ψ} indicates the deviation of the measured yaw rate \dot{ψ} from the nominal yaw rate.

In this arrangement, the rolling moment distribution is adjusted both by the skyhook control and by the yaw-rate-responsive control of the invention using adjustment dampers.

The rolling moment support controlled by ESP exhibits a considerably lower rate of yaw rate errors Δ\dot{ψ}, and an initial speed that is by almost 5% higher is achieved.

The cause for the more harmonious variation of the yaw rate in the ESP control and the higher driving speed can be seen in the diagram of FIG. 3b.

The said diagram shows the time variation of the brake pressure P controlled by ESP in the case of the same lane change, for which the data for the diagram in FIG. 3a was detected. The brake pressure P at the left front wheel (VL), at the right front wheel (VR), at the left rear wheel (HL), and at the right rear wheel (HR) is shown. The topmost diagram in FIG. 3b illustrates the activity of the ESP. The value 1 indicates irrespective of the generated brake pressure that an ESP control operation was performed, and the value 0 indicates that no ESP control operation was performed.

It can be seen in the diagrams that ESP in the stand-alone skyhook control is required to stabilize by means of brake interventions much more frequently than in the rolling moment support responsive to yaw rate.

The diagrams show that the method of the invention renders it possible to achieve a major improvement of driving performance and, hence, also vehicle safety.

Thus, the invention at issue provides a favorable control system related to the driving state, which allows calculating rolling moment distributions that noticeably improve the consequential vehicle behavior for the driver by using driver specifications and the vehicle reaction detected by sensors. An adjustment system is utilized to this end, which permits actively distributing the rolling moments of the vehicle body between front and rear axles, e.g. by way of active rolling stabilizer systems. Alternatively, likewise active spring and damper systems can be used for the rolling moment distribution. Both systems allow a static and dynamic rolling moment distribution.

### LIST OF REFERENCE NUMERALS

210 subtracter
220 PD-controller
230 unit for calculating a rolling moment distribution
240 adder
250 rolling stabilizer system
260 basic stabilizer control
e control variable
u control variable
w signals of instantaneous rolling moment distribution
P parameter
EG self-steering gradient
l wheel base
v vehicle longitudinal speed
δ steering angle at the wheel
μ coefficient of friction
\dot{ψ} actual yaw rate
\dot{ψ}_{ref} nominal yaw rate (yaw rate adjusted by the driver)
\dot{ψ}_{Soll} nominal yaw rate
Δ\dot{ψ} yaw rate error
Δ\tilde{F}_{VA} instantaneous wheel load difference at the front axle
Δ\tilde{F}_{HA} instantaneous wheel load difference at the rear axle
ΔΔF_{VA} change of wheel load difference for the front axle
ΔΔF_{HA} change of wheel load difference for the rear axle
ΔF_{VA} wheel load difference at the front axle
ΔF_{HA} wheel load difference at the rear axle
P brake pressure
VL left front wheel
VR right front wheel
HL left rear wheel
HR right rear wheel

1-25. (canceled)

26. A method of controlling driving dynamics of a vehicle comprising:
determining driving performance of the vehicle by comparing a nominal value (\dot{ψ}_{ref}) of a driving state variable that corresponds to a preset driver input with a detected actual value (\dot{ψ}) of the driving state variable;
detecting a rolling moment distribution is detected and modified;
determining a new rolling moment distribution is determined which corresponds to a predefined driving performance depending on the determined driving performance; and
adjusting the new rolling moment distribution.

27. A method according to claim 26, wherein the new rolling moment distribution is adjusted by actuation of at least one stabilizer at a front axle and/or a rear axle of the vehicle.

28. A method according to claim 26, wherein the new rolling moment distribution is adjusted by actuation of at least one adjustable damper at a wheel.

29. A method according to claim 26, wherein the rolling moment distribution of the vehicle is changed dynamically.

30. A method according to claim 26, wherein the rolling moment distribution is changed statically.

31. A method according to claim 26, wherein a self-steering behavior of the vehicle is ascertained.

32. A method according to claim 31, wherein a new rolling moment distribution is adjusted, which corresponds to a desired self-steering behavior.

33. A method according to claim 31, the self-steering behavior of the vehicle is determined using a comparison between the nominal yaw rate (\dot{ψ}_{ref}) and a detected actual yaw rate (\dot{ψ}).

34. A method according to claim 26, wherein the nominal yaw rate (\dot{ψ}_{ref}) is determined using a steering angle adjusted by the driver and a vehicle longitudinal speed.

35. A method according to claim 26, wherein a neutral self-steering behavior is detected if the amount of the nominal yaw rate (\dot{ψ}_{ref}) equals the amount of the actual yaw rate (\dot{ψ}).

36. A method according to claim 26, wherein an understeering self-steering behavior is detected if the amount of the nominal yaw rate (\dot{ψ}_{ref}) exceeds the amount of the actual yaw rate (\dot{ψ}).

37. A method according to claim 26, wherein an oversteering self-steering behavior is detected if the amount of the nominal yaw rate (\dot{ψ}_{ref}) is inferior to the amount of the actual yaw rate (\dot{ψ}).

38. A method according to claim 26, wherein a rolling moment support is displaced in the direction of the rear axle if understeering of the vehicle is detected.

39. A method according to claim 26, wherein a rolling moment support is displaced in the direction of the front axle if oversteering of the vehicle is detected.

40. A method according to claim 26, wherein at least one of a brake or engine intervention is performed in addition to at least one of a stabilizer or damper actuation.

41. A method according to claim 40, wherein at least one of the stabilizer or damper intervention, the brake intervention, or the engine intervention is tuned.

42. A method according to claim 40, wherein the stabilizer, damper, brake and engine interventions are performed in consideration of a critical value of the driving state variable which must not be exceeded.

43. A device for controlling driving dynamics of a vehicle, the device comprising:
a device for rolling moment support at front and rear axles of the vehicle;
sensors for sensing at least one driving state variable (\dot{ψ}) for the vehicle;
a subtracter (210) for determining a difference between a value of the driving state variable (\dot{ψ}_{ref}) adjusted by a driver and a detected value of the driving state variable (\dot{ψ});
a controller (220) for determining a correcting variable (u) from a difference between the value (\dot{ψ}_{ref}) adjusted by the driver and the detected value of the driving state variable (\dot{ψ});
an unit (230) for calculating changes of a wheel load differences at the front axle (ΔΔF_{VA}) and the rear axle (ΔΔF_{HA}) from the correcting variable (u) and a detected rolling moment distribution (w) between front and rear axles,
an adder (240) for adding the calculated changes of the wheel load differences at the front axle (ΔΔF_{VA}) and the rear axle (ΔΔF_{HA}) to instantaneous wheel loads at the front axle (Δ\tilde{F}_{VA}) and at the rear axle (Δ\tilde{F}_{HA}), and
an interface for actuating the device for the rolling moment support depending on the sum (ΔF_{VA}, ΔF_{HA}) of the calculated changes of the wheel load differences (ΔΔF_{VA}, ΔΔF_{HA}) and the instantaneous wheel load differences (Δ\tilde{F}_{VA}, Δ\tilde{F}_{HA}).

44. A device according to claim 43, wherein the device for the rolling moment support are stabilizers.

45. A device according to claim 43, wherein the device for the rolling moment support are adjustable dampers.

46. A device according to claim 43, wherein the sensors include at least one sensor for detecting the yaw rate

47. A device according to claim 43, wherein the controller (220) is a PD-controller.

48. A device according to claim 47, wherein the P-component of the PD-controller (220) considers the yaw rate.

49. A device according to claim 47, wherein the D-component of the PD-controller (220) considers the yaw acceleration.
